(19) United States
(12) Patent Application Publication
(10) Pub. No.: US 2012/0209632 A1
(43) Pub. Date: Aug. 16, 2012

(54) TELEMATICS SMART PINGING SYSTEMS AND METHODS

(75) Inventors: Charles Kaminski, Alpharetta, GA (US); Ash Hassib, Acworth, GA (US)

(73) Assignee: LexisNexis Risk Solutions Inc., Alpharetta, GA (US)

(21) Appl. No.: 13/350,388

(22) Filed: Jan. 13, 2012

Related U.S. Application Data
(63) Continuation-in-part of application No. 13/012,400, filed on Jan. 24, 2011.

(51) Int. Cl. G06Q 40/08; G06F 15/00; G06F 7/00

(52) U.S. Cl. 705/4; 701/1; 702/150

(57) ABSTRACT

Monitoring systems and methods are configured to determine a pattern of vehicle usage or to verify personal data about a vehicle insurance applicant, without unreasonable expense to an insurance provider or the applicant. A monitoring system can track movements of a handheld mobile communication device or rely on an application installed on said device, and can include a personal data unit, a communication unit, and an analysis unit. The personal data unit can receive personal data about the insurance applicant, including an identifier of a mobile communication device used by the insurance applicant.

### CROSS REFERENCE TO RELATED APPLICATIONS

This application is a continuation-in-part of U.S. patent application Ser. No. 13/012,400, filed 24 Jan. 2011, and entitled “Telematics Smart Pining Systems and Methods,” which is incorporated herein by reference in its entirety as if fully set forth below.

### TECHNICAL FIELD

Various embodiments of the present invention relate to the monitoring system and, more particularly, to cost-effective telematics systems and methods for monitoring insurance applicants by pinging or otherwise tracking carryable mobile communication devices.

### BACKGROUND

Conventional methods used by insurance providers to determine costs of motor vehicle insurance involve gathering relevant personal data, such as historical driving data as well as information about an applicant's driving and garaging habits, from the applicant and referencing the applicant's public motor vehicle driving records. Such data generally results in a classification of the applicant to a broad actuarial class for which insurance rates are assigned based upon empirical experiences of an insurance provider. Various factors can be relevant to classification in a particular actuarial class, such as age, sex, marital status, garaging location, and driving record. Based on the personal data received from and about the applicant, the insurance provider can assign the applicant to an actuarial class and then assign an insurance premium based on that actuarial class.

Because a selected insurance premium is dependent on the applicant's personal data, a change to that personal data can result in a different premium being charged, if the change results in a different actuarial class for the applicant. For instance, if a first actuarial class includes drivers between the ages of 36 and 40, and a second actuarial class includes drivers between the ages of 41 and 45, then a change in the applicant's age from 38 to 39 may not result in a different actuarial class, but a gradual change from 38 to 45 may result in a changed actuarial class and thus a changed insurance premium.

A principal problem with these conventional insurance determination systems is that the personal data collected from the applicant is generally not verifiable. For instance, the insurance provider may have no means to verify the applicant's mileage per year or the applicant's garaging location, either of which can be relevant to the selected insurance premium. Accordingly, the insurance provider's categorization of the applicant into a certain actuarial class may be based on false or incomplete information about the applicant, which can in turn result in an insurance premium that does not accurately reflect the risk of insuring the applicant.

### BRIEF SUMMARY

There is a need for a monitoring system for monitoring an insurance applicant or other entity without the necessity for equipment in addition to what is likely already owned by the applicant. It is to such systems and related methods that various embodiments of the invention are directed.

Briefly described, various embodiments of the invention are monitoring systems configured to approximate a transportation pattern of a motor vehicle based on tracking of and by a mobile communication device associated with an insurance applicant or other entity. In an exemplary embodiment, the mobile communication device can be a carryable handheld device, such as a mobile cellular device, mobile phone, mobile computing device, or other mobile electronic device. The mobile communication device can be tracked by the monitoring system to estimate movements of a motor vehicle sought to be covered by motor vehicle insurance, or driving patterns of the insured can be collected through a mobile application on the device itself

Over time, these movements and patterns can be used to build a profile around the insured driver, allowing for identification and risk analytics for insurance purposes. Additionally, a movement signature can be created to identify data relating to a particular applicant.

The monitoring system can include a personal data unit, a communication unit, and an analysis unit. The personal data unit can receive personal data about the insurance applicant, including a telephone number or other identifier of a mobile communication device used by the insurance applicant. The communication unit can receive driving characteristic data related to the mobile communication device, where the location data describes various locations of the mobile communication device over time and movement data describes location agnostic movements of a motor vehicle in which the mobile device is situated during driving. This movement data includes, but is not limited to, speed, acceleration, turning, and braking. In some embodiments of the monitoring system, the communication unit can periodically contact the mobile communication device itself to receive periodic driving characteristic updates as collected by the device and any relevant applications installed on the device. Alternatively, however, the communication unit can receive historical location data from a data center, such as a mobile service provider, associated with the mobile communication device. The analysis unit can analyze the location and movement data to determine movements of the mobile communication device and, thus, a pattern of usage of a motor vehicle used by the insurance applicant. Analysis of the driving characteristic data can then be used by an insurance provider to determine a level of risk for insuring the entity as well as to identify an entity through a driver signature comprised of aggregated movement data. This signature helps to ensure that risk models based on the monitoring systems analyses are applied to the appropriate, relevant entity

These and other objects, features, and advantages of the monitoring system will become more apparent upon reading the following specification in conjunction with the accompanying drawing figures.

### BRIEF DESCRIPTION OF THE FIGURES

FIG. 1 illustrates a diagram of a monitoring system, according to an exemplary embodiment of the present invention.

FIG. 2 illustrates a flow diagram of a method of utilizing the monitoring system, according to an exemplary embodiment of the present invention.

### DETAILED DESCRIPTION

To facilitate an understanding of the principles and features of the invention, various illustrative embodiments are explained below. In particular, the invention is described in the context of being a monitoring system for tracking the location and driving movements of insurance applicants, so as to determine vehicle usage patterns for the insurance applicants, thereby enabling an insurance provider to effectively assess insurance risks. Embodiments of the invention, however, are not limited to this context. Rather, embodiments of the invention can be used to monitor various individuals in various circumstances where accurate data about the individuals' movements would be useful, including an application on the device that collects driving behavior over time in order to build movement signatures around specific individual drivers.

The materials and components described hereinafter as making up various elements of the invention are intended to be illustrative and not restrictive. Many suitable materials and components that can perform the same or similar functions as the materials and components described herein are intended to be embraced within the scope of the invention. Such other materials and components not described herein can include, but are not limited to, similar or analogous components developed after development of the invention.

Various embodiments of the present invention are monitoring systems and methods to monitor movements of insurance applicants through driving characteristic data collected through mobile communication devices. Referring now to the figures, in which like reference numerals represent like parts throughout the views, various embodiment of the monitoring system will be described in detail.

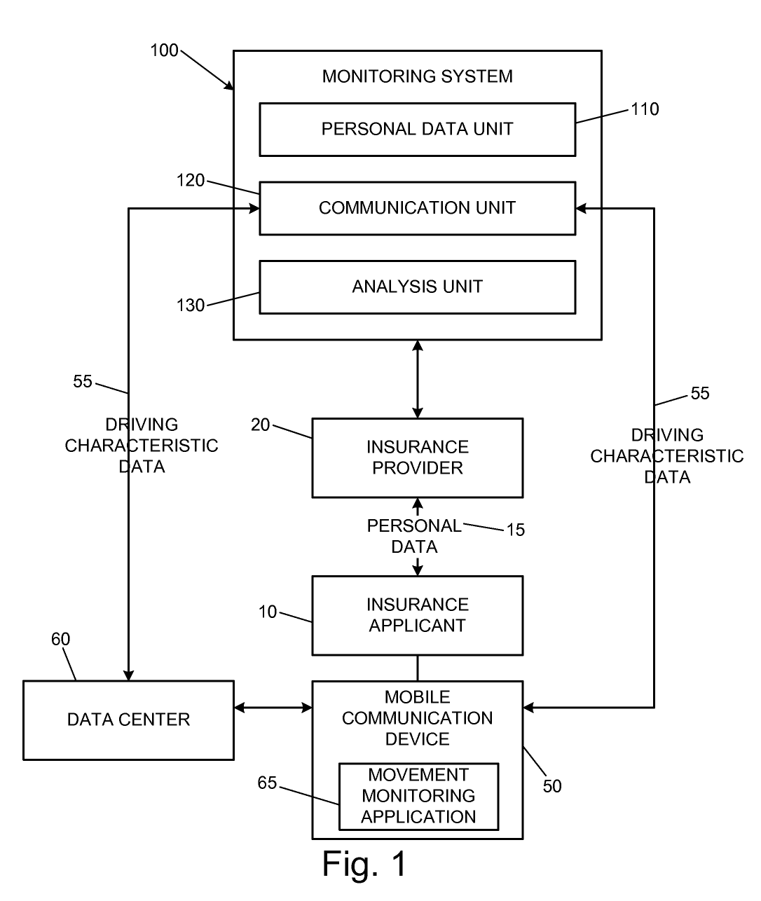

FIG. 1 illustrates a diagram of a monitoring system 100, according to an exemplary embodiment of the present invention. As shown in FIG. 1, the monitoring system 100 can include a personal data unit 110, a communication unit 120, and an analysis unit 130. Some exemplary embodiments of the monitoring system 100 can be embodied, at least in part, in a computer-readable medium for execution by a processor of a computing system. If this is the case, one or more of the personal data unit 110, the communication unit 120, and the analysis unit 130 can be implemented as computer hardware or software, or as an application installed on the mobile device itself.

The personal data unit 110 can receive personal data 15 about the insurance applicant 10. The received personal data 15 can be provided directly by the applicant 10 to the insurance provider 20 or can be provided by third party sources, such as by a motor vehicle administration or through other publicly available records. The personal data 15 can include various personal information about the insurance applicant 10, including for example, name, address, phone number, marital status, age, and date of birth. The personal data 15 can also include information about the applicant's activities and about motor vehicles operated by the applicant 10, such as, for example, driving record, registration tag number, vehicle identification number, vehicle garaging location, distance between home and office, and approximate miles driven per year.

In a conventional insurance system, an insurance provider 20 would decide whether to offer insurance to the applicant 10 and would determine an insurance premium based on this personal data 15 alone. Unfortunately, conventional systems fail to verify this personal data 15 and thus inaccurately estimate the risk of insuring some applicants 10.

The monitoring system 100 can approximate a pattern of vehicle usage, which can be used by insurance providers to verify the personal data 15 for purposes of identifying applicants as they drive and more accurately assess the potential risk of insuring the applicant 10. According to various embodiments of the present invention, the personal data 15 can include contact or identification information of a mobile communication device 50 associated with the insurance applicant 10. The mobile communication device 50 can be, for example, a mobile telephonic device, a mobile cellular device, a mobile computing device, or other handheld mobile device that is carryable by the applicant 10 on a regular basis. In some embodiments of the monitoring system 100, the mobile communication device 50 can be installed in, i.e., physically attached to, a motor vehicle with screws, clasps, or another attachment mechanism. Even if installed in a motor vehicle, the mobile communication device 50 can operate independently of the motor vehicle and need not be in electronic communication with the motor vehicle. In an alternative embodiment, the mobile communication device 50 can be an OnBoard Diagnostic (“OBD”) Device that is mounted in a vehicle in a communication with the OnBoard Diagnostic connector, such as a OBD-I, OBD-1.5, or OBD-II connector.

In other embodiments, the mobile communication device 50 collects location and movement data 55 through an installed application which feeds driving characteristic data 55 into the monitoring system 100. In this exemplary embodiment, the driving characteristic 55 data are collected by a movement monitoring application 65. In an exemplary embodiment, the movement monitoring application 65 can be resident on the mobile communication device 50 and can be configured to be executed by the processor of the mobile communication device 50. Those of skill in the art will appreciate that various hardware and software configurations can be implemented on the mobile communication device 50 to configure the operation of the movement monitoring application 65, such as utilizing the existing hardware components of the mobile communication device 50 or relying upon additional hardware components to be added to the mobile communication device 50. In one exemplary embodiment, the movement monitoring application 65 can rely upon an accelerator in the mobile communication device 50 to monitor and collect data regarding the movement of the mobile communication device 50. Additionally, an exemplary embodiment of the movement monitoring application 65 can rely upon data received from a Global Position System (“GPS”) chip in the mobile communication device 50 to monitor and collect data regarding the location and movement of the mobile communication device 50. In a further exemplary embodiment, the movement monitoring application 65 can rely upon data from both an accelerometer and a GPS chip to monitor and collect data regarding the location and movement of the mobile communication device 50. Those of skill in the art will appreciate that hardware in addition to a GPC chip and an accelerometer can be provided in communication with the mobile communication device 50 to provide driving characteristic data 55 to be collected by the movement monitoring application 65.

It can be presumed that movements of the mobile communication device 50 correspond to movements of the insurance applicant 10. However, a significant problem exists in determining whether the driving characteristic data 55 transmitted from the mobile communication device 50 actually relates to the applicant's 10 driving or whether the applicant 10 is simply a passenger in a moving vehicle. In accordance with an exemplary embodiment of the present invention, the monitoring system can analyze and aggregate driving characteristic data 55 over time and create a movement signature relating to the an individual applicant's 10 driving characteristics. This movement signature can be associated with a particular individual applicant 10; thus, the movement signature can be used by an exemplary embodiment of the monitoring system 100 to help identify when a particular insurance applicant 10 is most likely directing motor vehicle movements. In an exemplary embodiment of the monitoring system 100, the analysis unit 130 analyzed the data transmitted by the mobile communication device 50 to determine a movement signature. Therefore, in an exemplary embodiment of the monitoring system 100, the movement signature generated by the analysis unit 130 of monitoring system 100 can be used to determine whether the data sent by the mobile communication device 50 actually relates to the driving characteristics of the insurance application of interest. For example, and not limitation, the analysis unit 130 can use the movement signature in the analysis of later data obtained from the mobile communication device 50 to determine which data should be disregarded.

Those of skill in the art will appreciate the applicant 10 is likely to have their mobile communication device 50 actively linked to the monitoring system 100 in many situations where the applicant 10 is in motion but the applicant 10 is not personally driving. In an exemplary embodiment, the analysis unit 130 of the monitoring system 100 can rely upon a stored movement signature to identify whether driving characteristic data 55 received from a mobile communication device 50 is related to the actual driving of that applicant 10. For example, and not limitation, as described above, if the applicant 10 is riding as a passenger in a car with his wife driving but his mobile communication device 50 is actively sending driving characteristic data 55 to the monitoring system 100, the analysis unit 130 can be configured to eliminate this data regarding his wife's driving based upon a comparison to the movement signature of the applicant 10. Accordingly, the analysis unit 130 can utilize the movement signature as a type of data authentication mechanism to assist in verifying that the driving characteristic data 55 received from a mobile communication device 50 is relevant to the applicant's 10 driving and thus the applicant's 10 insurance risk level.

In an exemplary embodiment, the analysis unit 130 of an exemplary embodiment of the monitoring system 100 can compare the driving characteristic data 55 received from a mobile communication device 50 of the applicant 10 to the movement signature of the application 10 and assign a verification score to the driving characteristic data 55. In this embodiment, the analysis unit 130 can be configured to only utilize driving characteristic data 55 in the analysis of an applicant's 10 insurance risk level when the verification score for the driving characteristic data is above a predetermined threshold value. Therefore, the analysis unit 130 can be dynamically configured to disregard driving characteristic data 55 with a verification score below a predetermined threshold value desired for a particular analysis of an applicant's 10 insurance risk level.

The communication unit 120 can receive driving characteristic data 55 describing various locations of the mobile communication device 50. As described, the driving characteristic data 55 can be received either directly from the mobile communication device 55, through a dedicated application installed on the device or from a data center 60, such as a mobile service provider that services the mobile communication device 50. An exemplary embodiment of the monitoring system 100 can use either or both of these driving characteristic data 55 gathering methods. Regardless of the method used, the mobile communication device 50 need not actively contact the monitoring system 100, but can simply respond automatically to requests from the communication unit 120 as needed. The mobile communication device 50 need not notify the applicant 10 of the requests, so the applicant 10 is not required to actively participate in the monitoring.

In some embodiments of the monitoring system 100, to receive the driving characteristic data 55, the communication unit 120 can periodically contact the mobile communication device 50, or a mobile network servicing the mobile communication device, with a request for the current location of the mobile communication device 50. For example, and not limitation, the communication unit 120 can ping the mobile communication device 50. In response to the request, the mobile network or the mobile communication device 50 can transmit to the communication unit 120 the current location of the mobile communication device 50 or, if location information is not currently available, an error indicating the lack of availability. The monitoring system 100 can then add this current location information, along with a time stamp, to the driving characteristic data 55 previously received and stored for the mobile communication device 50.

Requests for updated location information can be sent by the communication unit 120 to the mobile communication device 50 periodically according to a schedule. For example, the requests can be sent at predetermined intervals, such as every hour. The intervals can be shifted and their durations modified as needed to fill any perceived gaps in a pattern of movement indicated by the driving characteristic data 55. For example, the requests can be made an hour apart, and the intervals can be shifted by ten minutes every 24 hours, or alternatively, the shifting schedule can be variable based on analysis of the driving characteristic data 55. In an exemplary embodiments, the driving characteristic data 55 can be gathered over a predetermined time period, such as a week, but this time period can be extended based on how often travel patterns are repeated. If patterns indicated by the driving characteristic data 55 are fairly regular, no additional monitoring after the predetermined period may be required. But if the patterns are not sufficiently regular, additional driving characteristic data 55 gathering can occur and can be scheduled based on perceived gaps in the patterns.

In some other embodiments of the monitoring system 100, the communication unit 120 can contact a data center 60 to request historical location information about the mobile communication device 50. The data center 60 can be, for example, a mobile service provider or server associated with a mobile service provider that provides services to the mobile communication device 50. For further example, if the mobile communication device 50 is a mobile phone, the data center 60 can be a server of a wireless service provider for the phone. From the data center 60, the communication unit 120 can request and receive information about past locations, along with corresponding time stamps, of the mobile communication device 50. This historical data can be provided to the communication unit 120 on one or more occasions, as requested by the communication unit 120. The location information received from the data center 60 can be added to any previously received driving characteristic data 55 related to the mobile communication device 50.

In some embodiments of the monitoring system 100, both of the above methods of receiving driving characteristic data 55 can be used. For example, the communication unit 120 can receive periodic updates directly from the mobile communication device 50 and can also receive historical location information from the data center 60 to supplement the information in the periodic updates. Alternatively, either method can be used individually to collect the driving characteristic data 55.

In some other embodiments, an application installed on mobile communications device 50 uses the device's own hardware to detect movements that map to automobile usage by the insurance applicant. These movements include, but are not limited to, speed of travel, acceleration, turning, and braking of the motor vehicle in operation by the applicant. This information can be sent to communication unit 120 at regular intervals according to a schedule so that the monitoring system 100 and can provide analysis of risk levels associated with movements over time and build a movement signature for specific insurance applicants. In an exemplary embodiment, the movement signature can based upon an observed pattern of driving by an applicant 10 as monitored and collected by the movement monitoring application 65 resident on the mobile communication device 50. For example, and not limitation, the movement monitoring application 65 can create a movement signature that identifies an applicant 10 that frequently brakes hard. Alternatively, the movement monitoring application 65 can create a movement signature that identifies an applicant 10 that typically accelerates at a consistent rate and rarely accelerates at a rapid rate. In an exemplary embodiment, the movement signature of an applicant 10 will represent an aggregate of movement patterns over an extended period of time.

In one embodiment, the movement signature of an applicant 10 can be generated by the analysis unit 130 of the monitoring system 100. In this embodiment, the movement monitoring application 65 on the mobile communication device 50 simply monitors, collects, and outputs data to the communication unit 120 of the monitoring system 100, such that the analysis unit 130 can process the driving characteristic data 55 obtained and generate an accurate movement signature of an applicant 10. In another embodiment, the movement monitoring application 65 and the analysis unit 130 can share the processing tasks of generating a movement signature for an applicant 10. For example, and not limitation, the mobile communication device 50 can disregard data that is determined to be irrelevant driving characteristic data 55 prior the transmission of the driving characteristic data 55 to the monitoring system 100. Disregarding irrelevant data by the mobile communication device 50 in an exemplary embodiment can reduce the load on the network and the mobile communication device 50 in sending irrelevant driving characteristic data 55 and also can beneficially reduce the amount of driving characteristic data 55 that must be stored and processed by the analysis unit 130 of the monitoring system 100.

In an exemplary embodiment, the movement monitoring application 65 on the mobile communication device 50 could be used to aggregate the driving characteristic data 55 and eliminate data 55 that is not relevant to a movement signature. For example, and not limitation, the movement monitoring application 65 can eliminate driving characteristic data 55 that appears to be gathered while the applicant 10 is traveling by a means not relevant to the monitoring system 100, such as riding public transportation. In an exemplary embodiment, the movement monitoring application 65 can analyze the location of the mobile communication device 50, and if it is determined that the applicant 10 is riding a metropolitan railway, such as the subway, either by analyzing location data or movement characteristics of the mobile communication device 50, then the data 55 obtained by the mobile communication device 50 while on the metropolitan railway can be deleted. Furthermore, in an alternative embodiment, the movement monitoring application 65 could determine an applicant 10 is riding a public transportation bus based upon detecting the braking and/or stopping of the mobile communication device 50 in locations in vicinity of known public transportation bus stops. Those of skill in the art will appreciate that a variety of methods can be employed to cull the aggregate data 55 collected, by both the movement monitoring application 65 and the analysis unit 130, to disregard irrelevant data.

The analysis unit 130 can analyze the combined driving characteristic data 55 and personal data 15 to determine a level of risk for insuring the applicant 10, based at least partially on movements of the mobile communication device 50 indicated by the driving characteristic data 55. The analysis unit 130 can draw conclusions about possible modes of transportation; boundaries on when, how long, and how far the applicant 10 traveled; to what degree applicant 10 has sped, turned, and stopped in his or her movements; and what general routes were taken. For example, based one vehicle usage patterns for a monitored period, the analysis unit 130 can estimate miles driven during a longer period, such as during an entire year. The analysis unit can interpolate and extrapolate as needed, according to predetermined algorithms, to estimate vehicle usage information. The specific types of analysis performed by the analysis unit 130 can vary widely based on the policies of the insurance provider 20 and based on how the analysis results will be used by the insurance provider 20.

In some embodiments, before conclusions are drawn, the analysis unit 130 can apply one or more algorithms in an attempt to correct errors in the driving characteristic data 55. Because the driving characteristic data 55 can be gathered directly or indirectly from a mobile network, the driving characteristic data 55 can inherently include errors derived from the mobile network's inability to precisely pinpoint the mobile communication device's location. As discussed above, the mobile network associated with the mobile communication device 50 can respond to location requests with location information for the mobile communication device 50, or a data center can provide historical location information that originated with a mobile network. More specifically, the mobile network can provide an approximate latitude and longitude of the mobile communication device 50, as well as an identification of the mobile tower, or cellular tower or other connection center, to which the mobile communication device 50 is currently connected. The reported latitude and longitude are generally imprecise, and the actual location of the mobile communication device 50 can be anywhere within the range of the mobile tower to which the mobile communication device 50 is connected. The range of each mobile tower can be known to the monitoring system and used for analysis. Accordingly, the below algorithms, which are provided herein for example only, can be used by the analysis unit 130 to approximate the location of the mobile communication device 50 given the imprecise location information received from the mobile network.

When using the “point” algorithm, the analysis unit 130 assumes that the position of the mobile communication device 50 is at the location of the mobile tower. Of course, this is an approximation, because the mobile communication device 50 may be located at any point within the entire range of the mobile tower and need not be located at the location of the mobile tower itself. Thus, with the point algorithm, every time the mobile network reports that the mobile communication device 50 has switched towers, the analysis unit 130 can assume that the mobile communication device 50 has moved.

In contrast, the “location” algorithm assumes that the mobile communication device 50 remains stationary, unless the reported location information directly contradicts this assumption. For example, suppose that Ping N is a ping that must indicate a movement from a previous location. Accordingly, the location algorithm assumes that the mobile communication device 50 just became stationary at the position (x,y)_{N} located within the range of tower T_{N}, which are the position and tower reported in the response to Ping N. For each future Ping M before the next movement of the mobile communication device 50 is recognized, the location information reported by the future Ping M, where the range of the tower reported overlaps with the range of

T_{N} and also overlaps with the ranges of all other towers reported in the pings occurring between N and M, is interpreted as non-movement. Accordingly, using the location algorithm, a movement of the mobile communication device 50 is recognized only when the reported location information must suggest a movement. If it is possible that the mobile communication device 50 remains stationary in light of a set of continuous location reports, which provide towers with overlapping ranges, then the location algorithm interprets the mobile communication device 50 as being stationary.

The above-described point algorithm may be best suited for insurance applicants known to travel relatively short distances, because the point algorithm favors a conclusion of movement as opposed to non-movement. In contrast, the location algorithm may be best suited for insurance applicants know to travel relatively long distances, because the location algorithm favors a conclusion of non-movement. As used here, the terms “long distance” and “short distance” are relative and depend on the concentration of mobile towers that are used by the mobile network to detect the location of the mobile communication device. More specifically, a “long” distance generally spans a greater number of towers than a “short” distance.

One of skill in the art will recognize that the above algorithms are examples that are presented only for illustrative purposes. Other algorithms can be substituted or combined with the above algorithms in various embodiments of the monitoring system 100 These could include more granular movement data beyond location and mileage as well as estimating movement signatures for applicants 10 based upon the aggregate of driving characteristic data 55 collected over time.

After performing any implemented error correction algorithms, the analysis unit 130 can determine one or more patterns or facts about the applicant's movements based on the driving characteristic data 55. For example, and not limitation, the analysis unit 130 can determine the mobile communication device's, and thus the applicant's, current and past modes of transportation by determining an approximate velocity of the mobile communication device 50 when using an appropriate sampling frequency. If the driving characteristic data 55 suggests a speed of 55 miles per hour over a time period of two hours sampled every half an hour, for example, the analysis unit 130 can determine that the applicant 10 is in a car or other automobile. Alternatively, for another example, if the driving characteristic data 55 suggests a speed of 350 miles per hours, the analysis unit can determine that the applicant 10 is in an airplane. Some embodiments of the analysis unit 130, instead of determining a specific mode of transportation, can simply determine whether or not the driving characteristic data 55 indicates that the applicant 10 is in the type of motor vehicle for which insurance is sought. Thus, if boat insurance is sought, the analysis unit 130 can determine whether various driving characteristic data 55 points correspond to the applicant's being in a boat, and is automobile insurance is sought, the analysis unit 130 can determine whether data points correspond to the applicant's being in an automobile. The analysis unit 130 can also determine, for example, an automobile's garaging location or miles driven.

The analysis unit 130 can place each applicant 10 in one or more categories that describe the applicant's vehicle usage. For example, and not limitation, each of a first set of categories can be defined by a range of estimated miles driven per year. Based on the driving characteristic data 55, the applicant 10 can be placed into one of these miles-driven categories. Categorization can be based on more than just the driving characteristic data 55, however. For example, a risk category can be determined for an applicant 10 based on a combination of the garaging location and estimated annual miles driven, both determinable from the driving characteristic data 55, along with one or more aspects of the personal data 15, such as the applicant's age and driving history. Additionally, more granular driving movements relevant to risk analytics, such as speed and abruptness of turning and stopping, can be processed through analysis unit 130. The analysis unit's categorization of the applicant 10 can determine, or can be considered in determining, the applicant's insurance premium.

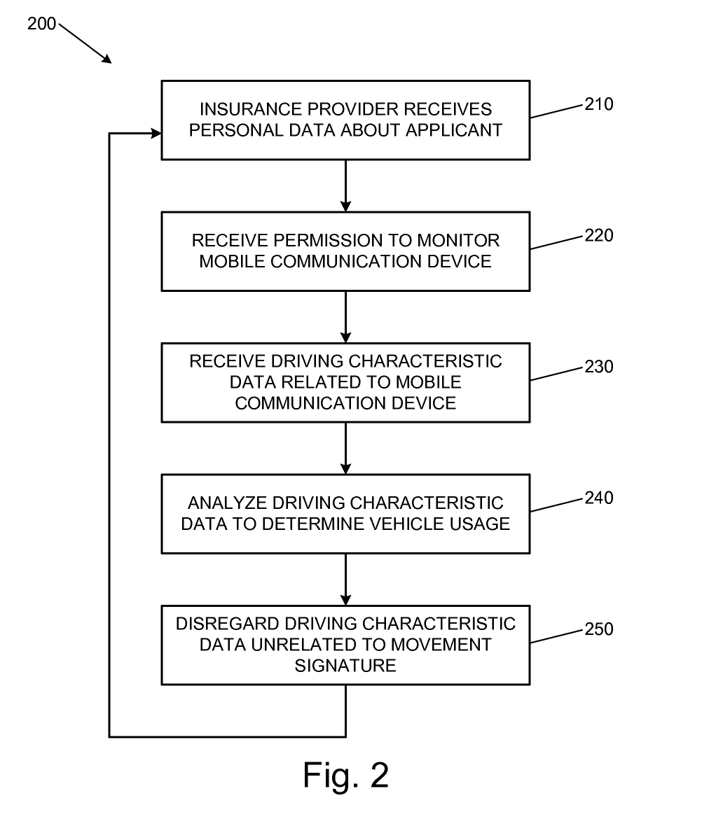

FIG. 2 illustrates a flow diagram of a method 200 of utilizing the monitoring system, according to an exemplary embodiment of the present invention. As shown in FIG. 2, at 210, an insurance provider 20 can receive personal data 15 about an insurance applicant 10. This personal data 15 can be received directly from the applicant 10, such as through an application, or can be received from third party sources. An identifier of a mobile communication device 50 carried by the applicant 10 can be included in the personal data 15 received. At 220, the monitoring system 100 can receive permission from the applicant 10 to monitor the mobile communication device 50. At 230, the monitoring system 100 can receive driving characteristic data 55 related to the mobile communication device 50. As discussed above, this driving characteristic data 55 can be compiled from data received directly from the mobile communication device 50, from a data center 60, or from a combination of both of these sources. At 240, the monitoring system 100 can analyze the driving characteristic data 55 to determine a vehicle usage pattern, which can be used by an insurance provider. At 250, the monitoring system 100 can be configured to disregard the driving characteristic data 55 that is determined to insufficiently related to the movement signature of the applicant 10 of interest. Therefore, at 250 the monitoring system 100 can help to ensure that the driving characteristic data 55 used to determine a vehicle usage pattern is actually data 55 that is related to the driving habits of the applicant of interest. As additionally shown in FIG. 2, this method 200 of determining a vehicle usage pattern can be revisited from time to time to reassess the applicant's insurance risk. For example, and not limitation, the method 200 can be repeated when the applicant's insurance policy is up for renewal or when changes are made to the applicant's personal data 15.

Various embodiments of the monitoring system 100 may have high value to an insurance provider 20, because the monitoring system 100 can verify personal data 15 without large expense to the insurance provider 20 or to the applicant 10. By utilizing hardware already included in mobile communication devices 50 or applications that are easily and cheaply installed on the device, which are carried by a large number of applicants 10, an insurance provider 20 can establish the monitoring system 100 on top of hardware and wireless infrastructures that already exist, as well as potentially affordable application/software, thus reducing or eliminating the need for stand-alone monitoring equipment to be purchased by the insurance provider 20 or applicants 10.

As discussed above in detail, embodiments of the monitoring system 100 can provide an effective means of determining an insurance risk for a vehicle insurance applicant 10. By monitoring a carryable mobile communication device 50 of the applicant 10, the monitoring system 100 can verify certain personal data 15 provided about the applicant 10, thereby establishing an insurance premium that accurately reflects the insurance risk involved.

While the monitoring system and method has been disclosed in exemplary forms, many modifications, additions, and deletions may be made without departing from the spirit and scope of the system, method, and their equivalents, as set forth in the following claims.

What is claimed is:

1. A method comprising:
requesting a plurality of driving characteristic data describing at least a plurality of movement patterns via a mobile communication device associated with an applicant;
receiving the requested driving characteristic data; and
determining a movement signature of vehicle usage for the applicant, based at least partially on the driving characteristic data.

2. The method of claim 1, further comprising comparing the driving characteristic data received from the mobile communication device of the applicant to the movement signature of the applicant to determine whether the driving characteristic data is related to the applicant.

3. The method of claim 2, further comprising disregarding the driving characteristic data that is unrelated to the applicant.

4. The method of claim 2, wherein the step of comparing the driving characteristic data involves assigning a verification score based on the comparison.

5. The method of claim 4, further comprising disregarding the driving characteristic data with the verification score below a predetermined threshold value.

6. The method of claim 1, wherein determining a movement signature of vehicle usage comprises determining a garaging location of a motor vehicle associated with the applicant.

7. The method of claim 1, wherein determining a movement signature of vehicle usage comprises categorizing the applicant based on times of day traveled.

8. The method of claim 1, wherein determining a movement signature of vehicle usage comprises categorizing the applicant based on non-distance or location related data such as acceleration, speed, braking, and turning.

9. The method of claim 1, the mobile communication device being a handheld mobile communication device configured to execute a movement monitoring application.

10. The method of claim 9, the movement monitoring application on the mobile communication device configured to monitor and collect the driving characteristic data.

11. The method of claim 9, the mobile communication device being configured to transmit the driving characteristic data absent an electronic connection to a motor vehicle.

12. The method of claim 9, the movement monitoring application configured to collect driving characteristic data from the mobile communication device, the driving characteristic data including at least information regarding acceleration, speed, braking, or turning.

13. The method of claim 9, wherein the movement monitoring application can disregard driving characteristic data that is not relevant to an applicant.

14. The method of claim 1, wherein the movement signature facilitates the identification of the applicant based on aggregated movement patterns.

15. The method of claim 1, further comprising applying a risk algorithm to the driving characteristic data to assess an insurance risk of the applicant.

16. The method of claim 1, further comprising determining whether the mobile communication device is located in an automobile, based at least partially on the driving characteristic data.

17. The method of claim 1, further comprising determining an approximate velocity of the mobile communication device, based at least partially on the driving characteristic data.

18. The method of claim 1, further comprising categorizing the applicant into one or more of a set of risk categories, based on the driving characteristic data.

19. A method comprising:
pinging a mobile communication device on a plurality of occasions, the mobile communication device being associated with an applicant;
receiving, in response to each ping, a plurality of driving characteristic data of the mobile communication device;
collecting the plurality of driving characteristic data in responses to the pings;
approximating past movements of the mobile communication device based at least partially on the plurality of driving characteristic data; and
determining an approximate pattern of vehicle usage for the applicant based at least partially on the past movements of the mobile communication device;
disregarding a portion of the plurality of driving characteristic data determined to be irrelevant to the applicant.

20. The method of claim 19, further comprising:
determining a movement signature of vehicle usage for the applicant, based at least partially on the driving characteristic data;
comparing the driving characteristic data received from the mobile communication device of the applicant to the movement signature of the applicant to determine whether the driving characteristic data is related to the applicant; and
disregarding the driving characteristic data that is unrelated to the applicant.

21. A system comprising:
a personal data unit configured to receive personal data about an applicant, the personal data comprising contact information for a mobile communication device associated with the applicant;
a communication unit configured to periodically receive driving characteristic data from the mobile communication device describing an updated location of the mobile communication device, and to associate the driving characteristic data with the applicant; and
an analysis unit configured to analyze the driving characteristic data to determine vehicle usage of the applicant, based at least partially on movements of the mobile communication device determined by the driving characteristic data.

22. The system of claim 21, the analysis unit being further configured to compare the personal data to the driving characteristic data to verify the personal data.
